(19) United States
(12) Patent Application Publication
(10) Pub. No.: US 2015/0040478 A1
(43) Pub. Date: Feb. 12, 2015

(54) Plant Growing Apparatus

(71) Applicant: Matthew Moghaddam, Newark, NJ (US)

(72) Inventor: Matthew Moghaddam, Newark, NJ (US)

(21) Appl. No.: 13/963,681

(22) Filed: Aug. 9, 2013

(51) Int. Cl. A01G 31/06

(52) U.S. Cl. CPC A01G 31/06
USPC 47/62 R

(57) ABSTRACT

According to certain embodiments, an apparatus for rotating a plurality of plants in and out of a nutrient solution and around a light source, wherein the row of plants is affixed at a specified angle to ensure proper nourishment for the plants, the rows having apertures to hold the plants and annular cross sections to house the nutrient solution, and a driving device to set the apparatus in motion.

### CLAIM OF PRIORITY

This filling claims priority to and the filing date of Provisional Patent Application No. 61/681309 to Matthew Moghaddam filed on Aug. 9, 2012, which is incorporated by reference herein in its entirety.

### BACKGROUND

### Field

Within the field of hydroponic agriculture, it is known that plants can be cultivated without soil utilizing a nutrient solution and light.

For instance, in the present disclosure a moving linkage supported by at least one frame moves skewed channels and at least partially submerges them in a nutrient solution in at least one point along their path.

### SUMMARY

Within the scope of the present disclosure a first embodiment of a growing apparatus includes at least, an elongated member moving a linkage on each end; a driving device affecting radial motion of said member; a channel with a first and second end arranged with one end higher than the other, such that the orientation becomes reversed as they cross a plane of the apparatus; wherein each channel has a plurality of apertures sized and shaped for plants to be placed therein; a structure between said linkages and the channels that swingably couples one to the other; a nutrient reservoir at the base of the apparatus, the reservoir containing a solution to nourish the plants housed in the channels; and at least one substantially rigid member providing operative support for the foregoing elements.

According to further embodiments of the present disclosure, the supporting frames comprise an H-frame, integral component, or an armature capable of providing mechanical support to the apparatus disclosed herein that would be apparent to someone of ordinary skill in the mechanical arts.

According to further embodiments of the present disclosure, the apparatus at least partially submerges the channels in the reservoir, wherein the linkage system is set in motion by translation of the drive sprocket and the drive sprocket is set in motion by the turning mechanism.

According to further embodiments of the present disclosure, is a light fixture disposed medially within the apparatus such that the channels may move unimpeded around and sufficient growing light is provided to the plants disposed therein.

### BRIEF DESCRIPTION OF THE FIGURES

In the figures, which are not necessarily drawn to scale, like numerals describe substantially similar components throughout the several views. The drawings illustrate generally, by way of example, but not by way of limitation, various embodiments discussed in the claims of the present document.

FIG. 1 is an isometric view of an embodiment a growing apparatus.

FIG. 2 is a front view of the embodiment of the present disclosure shown in FIG. 1.

FIG. 3 is an isometric enlarged view of a channel and its requisite mounting hardware.

### DETAILED DESCRIPTION OF THE FIGURES

Various embodiments of the presently disclosed apparatus will now be described in detail with reference to the drawings, wherein like reference numerals identify similar or identical elements. In the drawings and in the description that follows, the term “proximal,” will refer to the end of a device or system that is closest to the operator, while the term “distal” will refer to the end of the device or system that is farthest from the operator. Similar, anatomical terms of reference such as dorsal, lateral, anterior, and posterior shall have their accepted meanings in the arts. Numerals after an item number denote repeating, substantially similar elements.

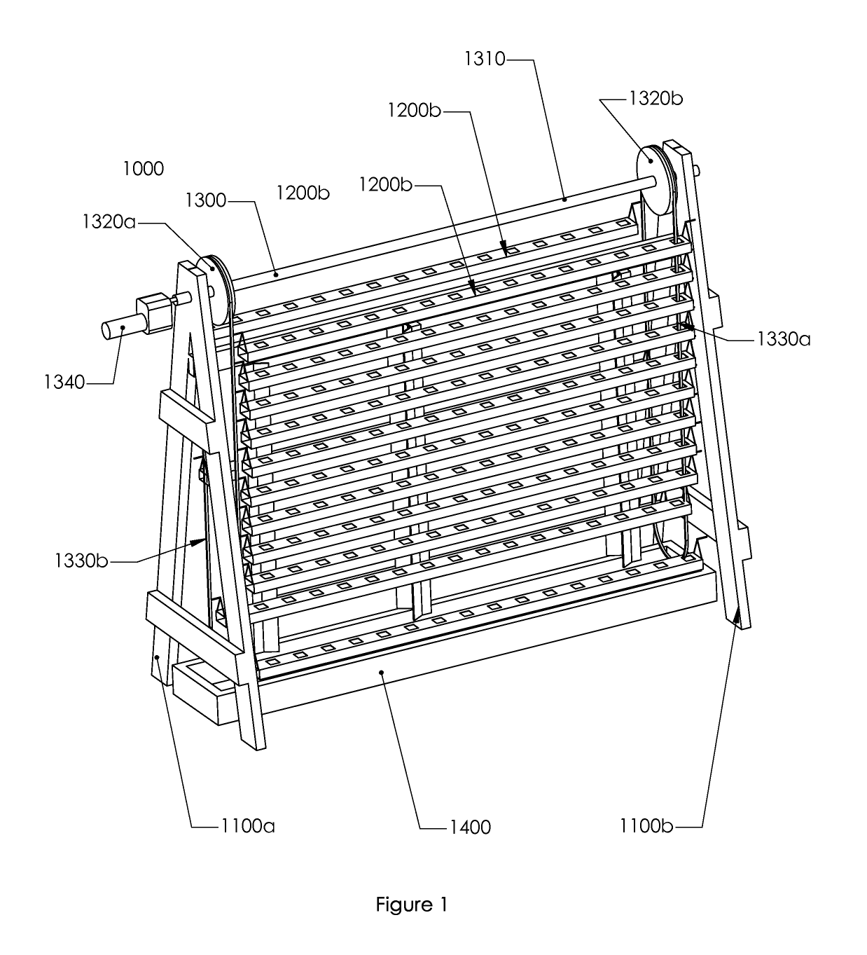

According to a first embodiment of the present disclosure shown in FIG. 1, a plant growing apparatus 1000 comprises of at least one support frame 1100(a-b), at least one channel 1200(a-v), a drive system 1300, and a nutrient reservoir 1400.

With continued reference to FIG. 1, the channels 1200(a-v) have at least one substantially dorsally facing aperture. These apertures support a plant and provide room for its roots to grow. Channels 1200(a-v) also contain apertures near the opposing ends thereof which allow fluid to flow out of channel 1200(a-v). In the current embodiment of the present disclosure, channels 1200(a-v) may be composed of polymers, resins, metals, or other substantially rigid materials to provide mechanical support to the plants disposed therein and fluidic communication amongst the roots thereof. Optionally, there may be included mechanical supports within the apertures, including for instance growing baskets.

With continued reference to FIG. 1, the drive system 1300 consists of an elongated member 1310 running through the top of the support frame 1100(a-b) and mechanically coupled to a drive sprocket 1320(a-b) located at lateral ends of the bar. Support frame 1100(a-b) may be an A-frame or any other substantially rigid support structure such as H-frame, wall portion, or truss to provide mechanical support.

With continued reference to FIG. 1, both elongated member 1310 and drive sprockets 1320(a-b) may be composed of a variety of polymers, metals, composite materials, or other substantially rigid materials able to withstand the rotational and sheer forces placed upon the respective structures. Linkages 1330(a-b) are elongated, flexible members situated about drive sprocket 1320(a-b) that extend in a substantially ventral direction toward nutrient reservoir 1400 and are there looped about a second pair of sprockets (not visible in FIG. 1).

With continued reference to FIG. 1, linkages 1330(a-b) couple the channels 1200(a-v) to the drive system 1300. Linkages may be composed of a metal, polymer, or other material capable of coupling the channels to the drive system apparent to someone having ordinary skill in the mechanical arts. Linkages 1330(a-b) may be chains, straps, gears, shafts, belts, acme rods, threaded rods, or other mechanical linkages not specifically shown in the figures.

The coupling of channels 1200(a-v) to linkages 1330(a-b) is uneven such that the first end of a given channel coupled to linkage 1330(a) is higher than a the second end of a given channel coupled to linkage 1330(b) such that fluid is able to flow to the lower, open end of the channel. Similarly, as the given channel crosses the apex of its travel, the first end that was previously the lower end now becomes the higher end and the second end that was previously the higher end becomes the lower end.

A driving device 1340 is coupled to elongated member 1310, drive sprockets 1320(a-b), or a combination thereof. Driving device 1340 may consist of a geared DC motor, AC motor, pulse wave, manual crank, or other drive methods known in the mechanical arts with sufficient output to power the movement of channels 1200(a-v) about their path.

With continued reference to FIG. 1, reservoir 1400 is a basin for holding a volume of nutrient solution located at the base of apparatus 1000. Reservoir 1400 provides sufficient surface area for at least partially submersion of channels 1200(a-v) therein at the nadir of its travel. The offset of each channel is between 0.5 and 25 degrees from horizontal.

Further embodiments of the present disclosure may situate driving device 1340 in a location other attached to elongated member 1310 or drive sprockets 1320(a-b). Such locations include, but are not limited to, the base of apparatus 1000, near the medial plane of apparatus 1000, or a remote location.

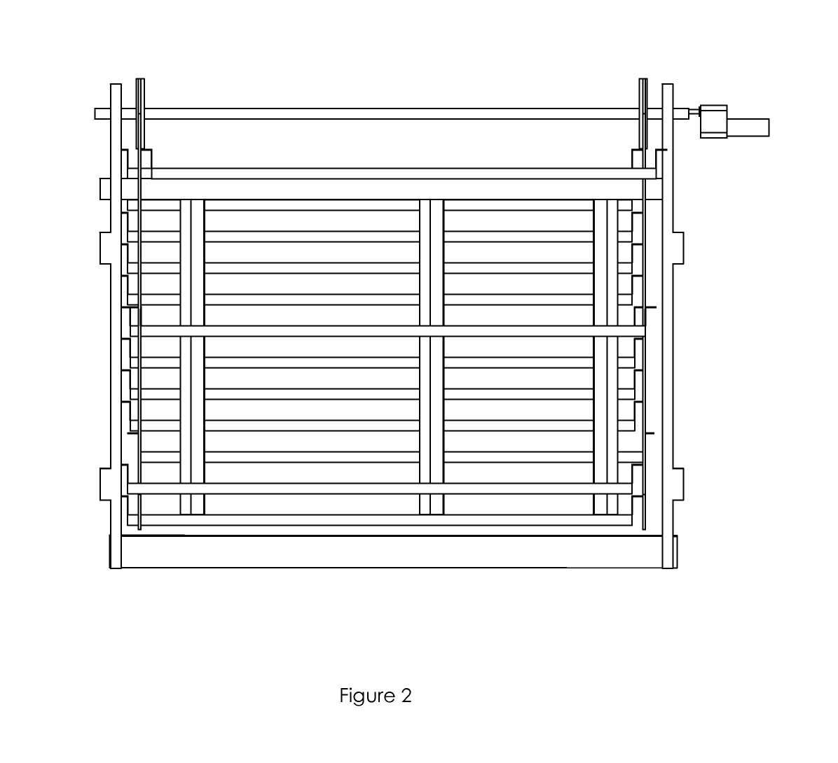

Referring now to FIG. 2, channels 1200(a-v) have a first and second end attached to linkages 1330(a-b) respectively in such a manner that one of the ends is disposed higher than the other end of a given channel 1200(a-v). The offset from horizontal of each channel 1200(a-v) is within the range of 0.5 to 25 degrees. The orientation of the channels is such that a first end of each channel is elevated relative to the second as the channel ascends in the growing apparatus. Conversly, after passing the apex of its range of motion, the second end of each channel is elevated relative to the first as the channel descends in the growing apparatus.

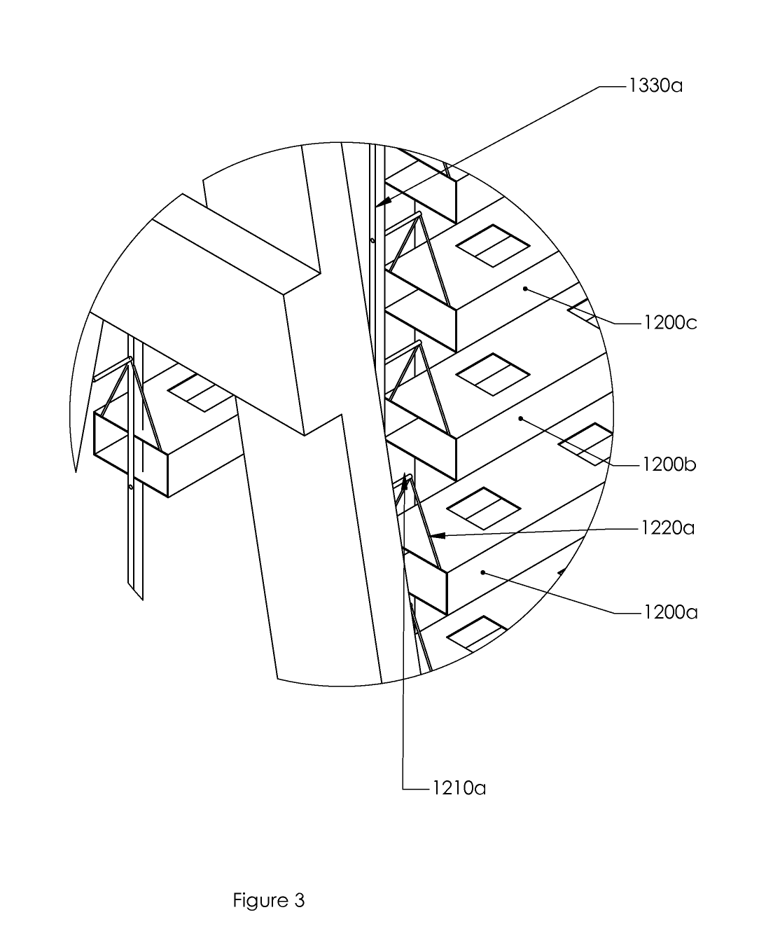

With reference to FIG. 3, channels 1200(a-v) are suspended from linkages 1330(a-b) by a link 1210(a-v). Link 1210(a-v) extends medially from linkages 1330(a-b) with link 1210(a-v) supporting a suspension 1220(a-v) that is connected to the ends of channels 1200(a-v). According to certain embodiments of the present disclosure suspension 1220(a-v) is a rigid member, a portion of braided wire or solid wire.

There is a fastener 1230(a-v) that swingably couples suspension 1220(a-v) to the channel 1200(a-v). Fastener 1230(a-v) may be a fastener, belt, or any other method of affixing link 1210(a-v) to linkages 1330(a-b). Links 1210(a-v), suspensions 1220(a-v), and fasteners 1230(a-v) may be composed of metals, polymers, or any other material that can connect and drive links and linkages apparent to someone of ordinary skill in the mechanical arts.

There is a contemplated embodiment of link 1210(a-v) including a pin with laterally complimentary grooves to linkage 1330(a-b). Upon depression of the end of the pin, the link 1210(a-v) becomes coupled or uncoupled to the linkage 1330(a-b). Such an arrangement allows for facile connection and disconnection of channels 1200(a-v) to apparatus woo.

At least one lighting fixture 1500(a-b) may be suspended from frames 1100(a-b), placed at the underside of channels 1200(a-v) or arranged in any other manner apparent to someone of ordinary skill in the horticultural arts which allows for the unimpeded movement of channels 1200(a-v) and for sufficient light to reach the plants. Lighting fixture 1500(a-b) may be constructed similarly to U.S. Pat. No. 2,338,077 given to Kenneth Seribner in 1943, which is incorporated by reference in its entirety. Lighting fixtures 1500(a-b) should emit a wavelength of light suitable for plant growth.

According to further embodiments of the present disclosure there is a c-shaped vertical channel disposed upon the lower edge of the ascending side of the device sized and shaped to minimize splash and spillage from the device.

According to further embodiments of the present disclosure, in place of (or addition to) a dunking reservoir at the bottom of the travel of the channels, there is a fixed sprayer nozzle disposed along the travel of the channel such that when a channel is disposed in the spray path of the sprayer, nutrient rich solution is transferred from the sprayer into the channel. The nozzle may be disposed in either a substantially parallel or substantially orthogonal to the long axis of the channels.

According to further still embodiments of the present disclosure, there is at least one catch basin disposed near the bottom of the assembly sized and shaped to capture excess nutrient solution and water therein.

A method of using plant growing apparatus 1000 will now be described. In a first configuration as shown in FIG. 1, apparatus 1000 is set in motion by the geared DC motor 1340 which radially translates elongated member 1310 and drive sprockets 1320(a-b). This movement sets linkages 1330(a-b) in motion and thereby moves channels 1200(a-v) vertically relative to the frame.

When so driven, the device has an ascending side and a descending side. When a given channel 1200(a-v) is located on the ascending side its first end is oriented higher than its second end. As a given channel 1200(a-v) crosses either the apex or bottom of its motion the orientation is reversed and the second side becomes higher than the first. When channel 1200(a-v) is at the bottom of its motion it becomes at least partially submerged in reservoir 1400, allowing the nutrient solution to enter via the apertures disposed at the ends of the channels thereby feeding the plants disposed therein. In the course of movement excess solution flows out of apertures located near the opposing ends thereof. The movement provides sufficient exposure to lighting fixtures 1500(a-b) to provide the necessary light to the plants for growth.

What is claimed is:

1. An apparatus for growing plants hydroponically, the apparatus comprising;
at least one substantially rigid elongated member having an annular cross section, with at least one aperture disposed thereupon and apertures near the opposite ends thereof providing access to internal space with the elongated member connected near its lateral ends to a linkage system thereby defining a channel;
a receptacle for housing plant nutrients located at the ventral end of the apparatus, the receptacle being of sufficient footprint to allow at least partially submersion of the channel therein thereby defining a reservoir;
at least one frame located on at least one lateral end of the apparatus, the frame providing structural support to the apparatus;
a driving device providing rotational movement to the drive sprocket;
at least one light fixture providing sufficient light for plant growth. at least one linkage system connected to the channel, the linkage system lying across at least one drive sprocket located at the dorsal edge of the apparatus, mechanically coupling the channel to the output of the driving device;

2. The apparatus of claim 1, further comprising:
a system for at least partially submerging the channel in the reservoir, wherein the linkage system is set in motion by translation of the drive sprocket, the drive sprocket set in motion by the driving device;
the movement of the linkage system at least partially submerging the channel into the reservoir and about at least one light fixture.
